(19) United States
(12) Patent Application Publication
(10) Pub. No.: US 2019/0155958 A1
(43) Pub. Date: May 23, 2019

(54) OPTIMIZED SEARCH RESULT PLACEMENT BASED ON GESTURES WITH INTENT

(71) Applicant: Microsoft Technology Licensing, LLC, Redmond, WA (US)

(72) Inventors: Rahul LAL, Redmond, WA (US); Marcelo DE BARROS, Redmond, WA (US); Hariharan RAGUNATHAN, Bellevue, WA (US); Shantanu SHARMA, New Castle, WA (US)

(73) Assignee: Microsoft Technology Licensing, LLC, Redmond, WA (US)

(21) Appl. No.: 15/839,579

(22) Filed: Dec. 12, 2017

Related U.S. Application Data
(60) Provisional application No. 62/588,816, filed on Nov. 20, 2017.

(51) Int. Cl. G06F 17/30; G06F 3/0488; G06F 3/0485

(52) U.S. Cl. CPC G06F 17/30905; G06F 17/30902; G06F 3/0485; G06F 3/04883

(57) ABSTRACT

System and methods are disclosed to provide optimized search result content placement based on gestures with intent. The system and methods addresses an issue of a search application accurately interpreting a query to provide search results that satisfy expectations, while minimizing unnecessary iterations of queries. The system and methods enable optimized updates of content and search results by translating user-interactive gestures on search results into intent of the search. Actions required to update the content and search results may be determined based on the intent. The translation from gesture into intent, and the determination of action based on the intent may be provided by mapping among gesture, intent, and action. The mapping data may be trained by success metrics data, which may generated by analyzing usage logs of the search application.

### CROSS REFERENCE TO RELATED APPLICATIONS

This application claims the benefit of U.S. Provisional Patent Application No. 62/588,816, filed on Nov. 20, 2017, titled “Optimized Search Result Placement Based Upon Touch Gestures,” the disclosure of which is hereby incorporated by reference herein in its entirety.

### BACKGROUND

Use of search applications is common in many computers and mobile devices such as smartphone. Search applications generally receive query input, retrieve search results from various locations and provide the search results to computers and mobile devices. Search results may be displayed according to various priority preferences, such as a level of relevance to the query. The search results may be displayed according to display sizes of computers and mobile communication devices. In order for the search applications to provide search results from an enormous amount of information effectively, however, placement of search results may significantly impact ease of navigating the content on the computers and mobile communication devices.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues may be resolved by optimizing search result content based on gestures, such as touch gestures, received through via a device. A touch gesture along with a location of the gesture on the screen may indicate intent or a degree of interests of the device operator while navigating through search results. For instance, a scrolling gesture of may translate into an intent to continue reading the search results. Touch gestures may provide a signal that may be analyzed to determine what regions of the page interests the user, and to what degree the user is interested in the content of the search result. Search applications may receive various touch gestures, automatically determine a user's intent based upon the received touch gestures, and, based upon the intent, perform one or more actions to update the content of the search results.

Received gesture may be associated with view port coordinates in the search result page to determine and intent and interests of users. A search application may uses the determined intent to updated the search results with new content or modify the content displayed on the search results page to provide the most relevant information more quickly than typical search applications. Furthermore, aspects of the disclosure may also include improvements to the design of search result page based on the user's intent and interests determined based upon the received touch gestures.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for search result content placement based on gestures on a touch screen phone.

FIGS. 2A-2B illustrate overviews of example systems for search result content placement based on gestures.

FIGS. 3A-3B illustrate block diagrams of example components of the disclosed search result content placement system.

FIG. 4 illustrates simplified data structure of gesture-intent-action mapping according to an example system.

FIG. 5A-H illustrate graphical user interface (GUI) according to an example system.

FIG. 6 illustrates a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Search engines and applications attempt to provide the most relevant results to in response to a query. In addition to the accurately selecting information from one or more data sources in response to receiving a query, search applications attempt to present search results in a way that allows a user to quickly find data most relevant to their query. Various factors may affect how search results are presented. For instance, the limited size of a display on a mobile devices, such as a smartphone, may impose significant restrictions on the amount of information that can be presented. Adding more content without enough spacing between the content items in the mobile search results page makes the search results page appear cluttered and thus hard for the user to quickly find an answer to their query. On the other hand, adding more space between content to avoid clutter increases the needs to scroll the content until desirable information is found, which also negatively affects the user experience. Moreover, search results have increasingly become more complex by including various types of media (e.g., web pages, images, videos, documents, etc.). A large amount of data may be required to transmit a search results page that includes said content, which impacts time required to transmit or load the search results page via a network as well as the time to render the search results on a device.

A query received by search applications may not always explicitly reflect intent of a user submitting the query. For instance, a search application may receive a query for “flowers” on a device. The search application may search for and provide search results based on the query word “flowers.” The intent of using the query may be unclear. In one aspect, the query for “flowers” may imply a search for a list of nearest flower shops. In another aspect, the query for “flowers” may imply a search for information on flower powder as ingredients for cooking. In yet another aspect, the query for “flowers” may be received with an intent to see specific flower-related websites. While a user's intent may not be query from the query, the user's intent for the query and/or degree of interest in presented search results may become derived based upon user interactions with the search results page. Initially, a search application may use the received query to search for information that may be relevant to the received query and provide search results based solely on the query. In existing search applications, if the search results do not satisfy the user's intent, the user may be required to submit additional queries that more accurately describe his or her intent. Iterations of receiving varying query words and providing search results for the query words may take place until a set of search results that are reflective with the intent is provided. Requiring such iterations of search operations may be time-consuming and also energy inefficient because of unnecessary power consumption on the device in communicating with content servers over the network and updating content. Aspects of the presenting disclosure, among other benefits, may determine an intent based upon the user's interaction with the search results and update the search results accordingly, without requiring the user to submit additional queries.

In some aspects, the present disclosure addresses an issue of providing search results accurately and effectively by determining an intent of the query based on user interactions with the search query. For examples, user gestures received while the user is navigation the search result may be used to determine the user's intent. For instance, touch gestures may be detected on the device. The touch gesture may then be translated into a user intent. The search application may update the search results based upon the derived user intent. In some instances, updating the search results may include automatically querying a data source for additional information based upon the derived intent. In some other instances, updating the search results may include querying the user to confirm that the derived user intent agrees with the user and receiving a new intent to apply.

In addition, the present disclosure may provide a balance between presenting sufficient information and pre-loading information through content cache management that relates to the user's intent. The user's intent may be determined based on a gesture that is received on the device through user interactions with the search results. Intent may be used to determine actions needed to update the current display with the content that more accurately relates to the user's intent and to selectively trigger pre-fetching of content based on the derived intent. One or more mappings may be used to translate received gestures into an intent and then translate an intent into one or more actions needed to update the content to satisfy the intent.

Aspects of the present disclosure may employ mappings between a received gesture, a user intent, and an action to be performed by the search application. An example intent may be a gesture of slowly scrolling a search result list. Based upon the slow scrolling gesture, it may be determined that the query results match the intent of the query because the user is taking time to read the search result content. Accordingly the search result list may be updated to show more items related to the currently displayed content by prefetching similar content to display as the user scrolls through the search results. On the other hand, receipt of a fast scroll gesture may be used to determine that the provided results do not satisfy the user's intent of the query because the user is skipping the displayed content. As such, a determination may be made that the content returned in the search results may be unrelated to information that the user desires. Accordingly, the based upon the intent derived from the fast scroll, aspects of the present disclosure may discards the cached content for the current search result page, and update the page by jumping to the top or the bottom of the search page to receive some other queries. Alternatively, aspects of the present disclosure may automatically submit a new query to one or more data sources and update the results of the search page in an effort to identify data that satisfies the user's intent.

In some aspects, the mappings between a gesture, an intent, and action to be performed by a search application may be dynamically updated based upon the history of user interactions with a search application. The mappings may be trained based on usage logs of the search application. For instance, logging services may be used to log user interactions as well as determinations of intent and actions based on received gestures. The logs may be stored both locally and remotely for analysis by the user device and/or a server or data source that generates the search results in response to a query. Usage logs may be used to generate success metrics of respective mappings. In some aspects, a success metrics score for a mapping between a gesture, an intent, and an action may be generated based on usage analysis. For instance, success metrics scores may be higher when a sequence of gestures requesting more detailed information on particular query terms is found based on the usage log. When determining intent and action based upon a received gesture, the mapping with the highest success metrics score may be selected. In some aspects the gesture mapping and client library may be updated based on success metrics scores. Subsequent processing of gesture-intent translations may use the latest gesture mapping to accurately capture user's intent during operations. In some other aspects the updated mappings may be shared across multiple users such that tendencies of gesture-intent mapping among users may be captured to maintain accuracy in gesture-intent translation.

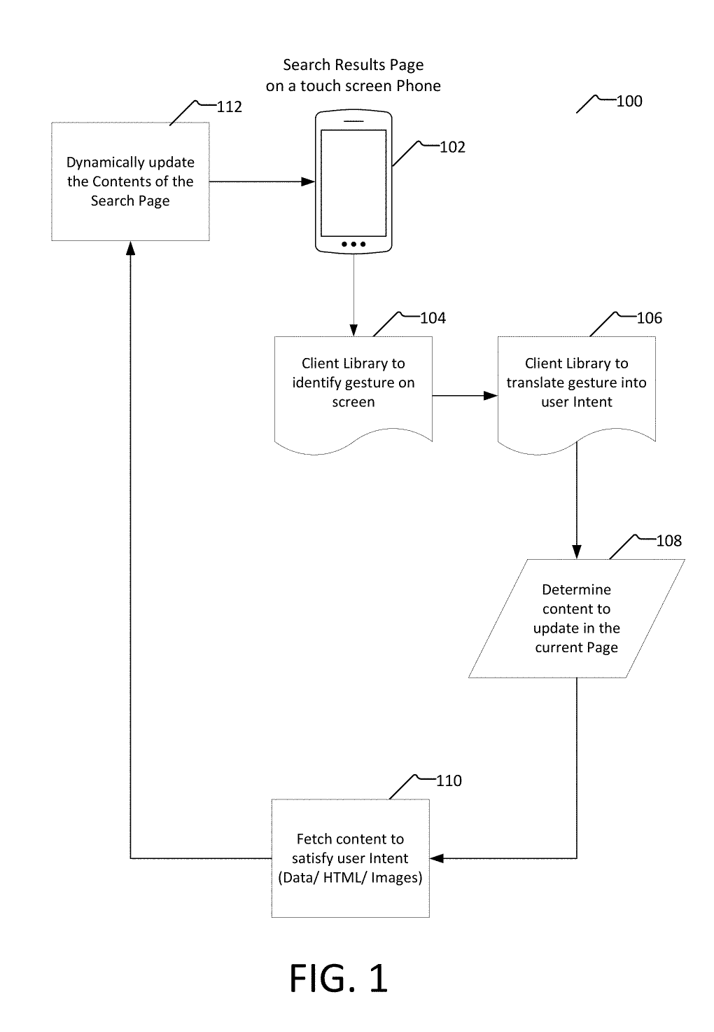

FIG. 1 illustrates an overview of an example process for search result content placement based on gestures on a touch screen phone. A system 100 may dynamically update search result content according to an intent of a user determined based on user interactions, e.g., touch gestures and other operational gestures made on a device such as a smartphone. The device may comprise a touch screen to receive input events based on fingers touching the screen.

At display operation 102, search results based on a query may be displayed on the device. The device with the search application may provide ways to navigate through the information displayed on the screen by scrolling through the list of search results and by selecting links to display (render) other information.

At identify operation 104, a client library may identify touch gestures received by the device. In some aspects, a client library may be installed on the device. Various types of touch gestures may be identified. For instance, touch gestures may include, but are not limited to, receiving a tapping at a specific location or a set of coordinates on the touch screen, a speed of swipe or scroll move, a length of the movement, at least one direction of the movement, and pinching by using at least two fingers. In some aspects, strength of the finger pressing the screen may be identified. A location of gestures may be expressed in terms of coordinates on the touch screen display. The location of the gesture on the touch screen may be correlated with one or more items of content on the touch screen. In some aspects, the identify operation 104 may be implemented as a client library that is directly linked to a device driver of the touch sensor device in the touch screen display.

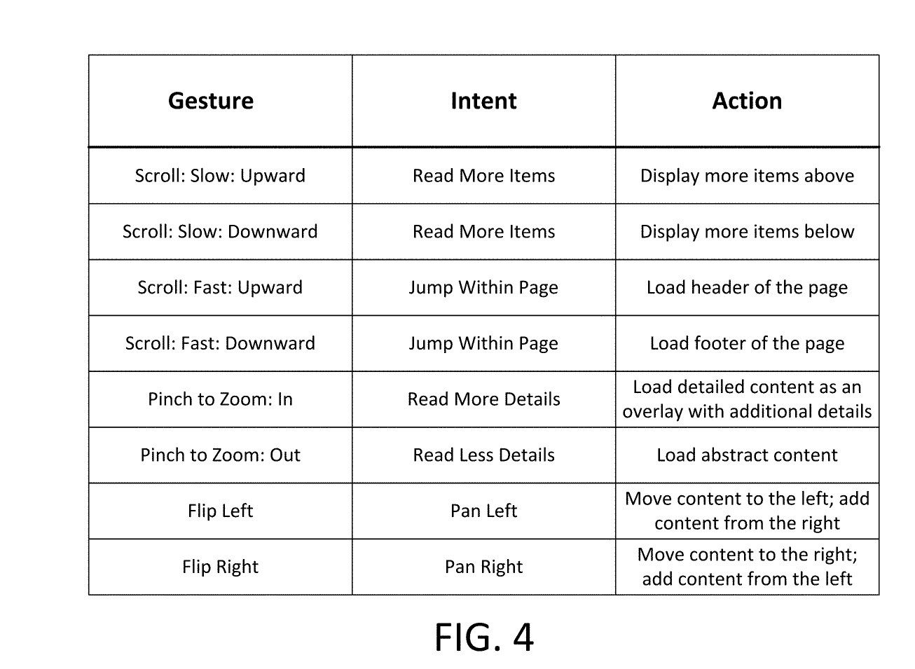

At translate operation 106, the client library installed on, but not limited to, the device may translate the identified touch gesture into user intent. The translation may be based on a mapping table, such as the table shown in FIG.4, which comprise definitions of a relationship between types of gestures and types of intent. The mapping table may further comprise actions that need to be executed in response to the identified gesture with the specific intent. For example, when a touch gesture “Scroll: Slow: Upward” is identified, the touch gesture may be translated into “Read More Items” as its corresponding intent and “Display more items below” as an action to update content. When the screen is scrolled upward at a slow speed on the search result page, the likelihood is such that the user is reading the search results carefully instead of just passing through the list items. In another instance, a touch gesture may be to pinch to zoom-in at some search result item. The gesture may be translated into an intent to see more detailed information about the search result item. Accordingly, an action may be determined to update the search result page with a page with detailed information about the item. While specific mappings are described herein to determine a user intent, one of skill in the art will appreciate that other mappings or other mechanisms for deriving intent may be employed without departing from the scope of this disclosure. Furthermore, while the aspects herein describe a client library installed on the device, it is contemplated that the library or the mapping table may reside on a remote device, such as a server. In such examples, information related to the received gestures and/or coordinates may be transmitted to the remote device.

At determine operation 108, specific search result content may be identified to be updated on the current search result page based on the derived intent. Receiving the action needed to execute based on the gesture and the intent, the present disclosure may determine content data to update in the current page. For instance, the search result content may be rendered according to a structure where the display area is partitioned into one or more content containers. Each container may manage a specific search result content to render. As gesture information may comprise a location within the display where a touch gesture occurred, the location information may be used to select a content container that occupies the location on the screen corresponding to the gesture. Based on the action to execute (e.g., determined by the intent) and the container information, aspects of the present disclosure may determine content data to update for respective containers. For example, as the device receives slow, upward swipe as a touch gesture on the search result page, the present disclosure may determine specific content, such as the next item on the search result list, to be rendered at the content container at the bottom of the page. In some aspects, the device may receive a pinch zoom-in touch gesture. The touch gesture may be translated into an intent to reach more details with respect to a search result item where the pinch-zoom occurred on the display. A specific content container for the search result item may be determined based on the location of the pinch-zoom touch gesture. Based on the requested action, the determined content may be for displaying a detailed information page for the selected search result item.

At fetch operation 110, content that satisfies the intent and its corresponding action may be retrieved. The content may be retrieved locally within the device or from content servers across the network. Content data may be in various types, such as but not limited to rich text, linked web content, images and video data. In some aspects, content data that are retrieved across the network may be locally stored in cache on the device. In aspects, fetching content may include retrieving content from a data source. In one aspect, if it is determined, based upon the intent, that the user desires to inspect a specific content item more closely, additional the specific content may be retrieved from a data source. For example, if the specific content item is a link to a web page, the web page, or portions of the web page, may be retired, for example, by sending a request for the web page content, and displayed in the search results. Alternatively, if a determination is made that other types of search results are desired by the user, based, for example, upon the device content, a new query may be automatically generated and executed, either locally or remotely, to identify new search results. The newly identified search results may be then be displayed without requiring the user to submit a new query.

At update operation 112, the search result page may be dynamically updated with content as determined according to the requested action that is performed based upon the derived intent. In some aspects, content may be retrieved from one or more local content cache memory on the device as content may be stored upon the fetch operation 110. Alternatively, content may be retrieved from a remote data store. In some aspects, respective operations including the identify operation 104, the translate operation 106, the determine operation 108, the fetch operation 110, and the dynamic update operation 112 may be processed concurrently to provide real-time response.

As should be appreciated, operations 102-112 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

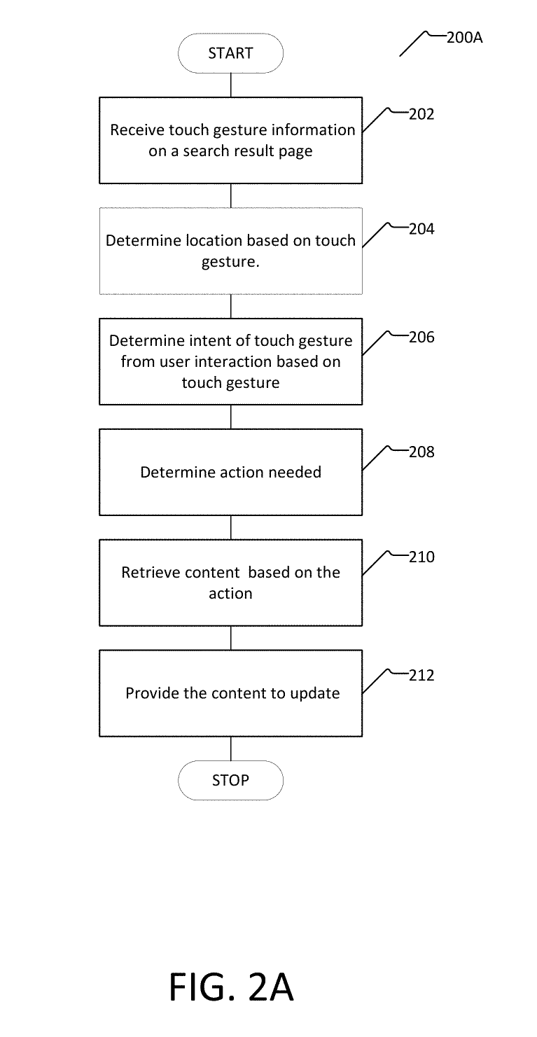

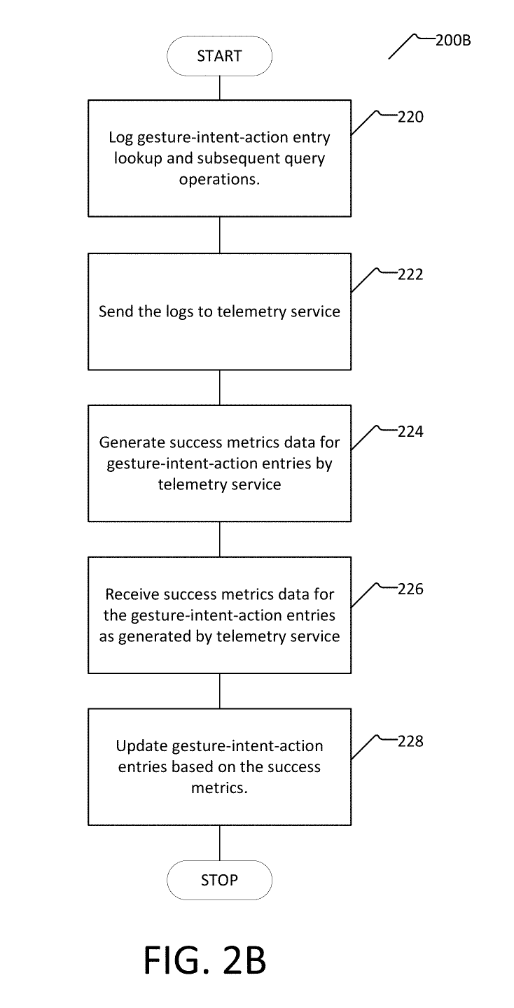

FIG. 2A Illustrates for an overview of example system for search result content placement based on gestures. A method 200A illustrates a set of processing steps that may be processed periodically or upon receiving some events to update content on the search results pages.

At receive operation 202, the system may receive touch gesture information directed to a search result page. In some aspects, a touch gesture may comprise an input on the touch-sensitive screen display on the device. Such a touch gesture may be received when at least one of object, such as a finger and/or a pen, contact the surface of the display. If the object moves while touching the display, the motion data of the object may be received by the device. The gesture data may comprise information about a location and received pressure where the object first touched, as well as direction, speed, trace of locations, and a final location where the object ceases to touch the display.

At determine operation 204, the system may determine a location on the display based on the received touch gesture. In some aspects, the location may be the initial point where the touch gesture occurred. For instance, the location may be where a slow downward scroll gesture occurs. In some other example, the location may be where a pinch zoom-in gesture occurs. In yet some other example, the location information may comprise a set of locations including the initial location of touching the display along with a set of location information that traces the motion of the object while the touch gesture takes places on the display.

At determine operation 206, the system may determine an intent based upon the gesture. In some aspects, a mapping table that maps a gesture to and intent and action may be used. An example of such table is as shown in FIG. 4. For instance, the system may receive a fast, downward scroll as a gesture. The mapping table be used to map the gesture to a jump (to the bottom) action within the page as a corresponding intent. In some other example, the system may receive a slow, upward swipe as a touch gesture. The mapping table may indicate, for example, the gesture being mapped to the intent to read more items. In yet another example, the gesture may be a pinch to zoom out. The mapping table may map the gesture to an intent to read less details of search result items.

At determine operation 208, the system determines an action needed based on the determined intent on the search result page. In some aspects, the system may use a mapping table such as the gesture-intent-action mapping table as shown in FIG. 4. For example, when the intent is determined as to jump within the search results, its corresponding action may be to load the footer of the search result page. In another example, when the intent is to read more items on the search result page, its corresponding action may be to display more search result items below the list. In yet another example, when the intent is determined as to read less details of search result items, the action may be to load abstract content with less details about the search result item.

In some aspects, an intent and action may be determined based on factors other than the mapping table. For instance, information such as location of device usage, time of day, user profile, a page number of the current search result page, a layout of the search result page such as a list format, a tile format, and an icon display format, to determine varying intent based on similar gestures.

At retrieve operation 210, the system may retrieve content according to the determined action. Specific content may be determined by selecting at least one content container that corresponds to a location of the received touch gesture. For instance, the selected content container may be a specific search result item. If the determined action is to display more details about the search result item that is displayed at a location where the touch gesture was made, the retrieve operation 210 may retrieve more detailed information about the search result item. If the determined action is to scroll the search result list, a set of content containers that need to be rendered may be identified as more parts of the list need to be displayed. Accordingly, specific content for updates to the search results may be identified based upon the action determined from the intent and/or one or more content containers. In some aspects, such content may be stored locally in the device using of read-ahead cache management. In some other aspects, the content may be retrieved from one or more content servers at a remote location via a network. Latency of the retrieve operation 210 may vary depending on the type of content. At the end of the retrieve operation 210, content may resides in the cache memory of the device for displaying.

At provide operation 212, the retrieved may be provided. For instance, the content may be used to update search results and displayed on the device. In some aspects, the retrieved content may be sent to a speaker of the device play the content if the content media type is audio as a search result. The present disclosure may provide the content as a search result that satisfies the intent behind having made the query by a user of the device.

As should be appreciated, operations 202-212 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

FIG. 2B Illustrates an overview of an example system for updating gesture determinations. In particular a method 200B illustrates a set of processing steps that may be processed periodically or upon receiving some events to train the mapping between gestures, intents, and actions. The mapping between one or more gestures, intents, and actions may dynamically change over time as one or more users of the device may have different patterns in searching for information. Having inaccurate mapping may significantly impact accuracy for the search application to provide search results that satisfy expectations. Training and updating the mapping table may enable the search application to provide accurate search results as the application may be used in various scenes.

At log operation 220, the performed actions and/or retrieved content performed based upon the gestures and as well as subsequent user interactions with the updated search results may be recorded. The log may contain both cases where the updated search results satisfy user intent and cases where the updated search results did not meet expectations of users and search results are not useful as distinguished by subsequent patterns of gestures while navigating search result content.

At send operation 222, the log data may be sent to a telemetry service at a remote location. The log data may be transmitted locally within the device or across the network. For instance, the log data may be transmitted to a telemetry server periodically. In some aspects, a telemetry service may be available at the telemetry server to receive and execute process-intensive tasks such as analyzing log data for tendencies of success and failure of operations on the device.

At generate operation 224, success metrics data for the gesture-intent-action mapping entries may be generated by the telemetry service. In some aspects, the telemetry service may analyze usage log to determine whether updated search results met expectations and intent of users. The log data may comprise look-up operations on the gesture-intent-action mapping table, and information on a subsequent gesture on the touch screen display after updating search results based on the mapping. Some gesture information on the log, such as pinch zoom-in gesture and slow scrolling, may indicate the user's interest in a specific content item of the search results. Such gesture reaction to the search result may signify that the derived intent and action taken based on the received gesture correspond to the user's actual intent. In some aspects, a subsequent gesture, such as fast scrolling and pinch zoom out may indicate that the updated search results are not in line with what the user's intent. In some other aspects, a fast scroll may simply mean an intent to jump to the end of the search result list to read the listed items from the end of the list instead of a lack of interests in the search results. Such difference in intent may affect efficiency of content cache management because cached content may need to be retained if the intent is to continue reading the search results. Accordingly success metrics data may be generated by the telemetry service for one or more entries in the gesture-intent-action mapping table. Success metrics data may be expressed as a probability of the mapping being correctly reflecting user's intent. In some aspects, the generation operation 224 may be processed on the device if the device has enough processing capability for the operation.

At receive operation 226, the success metrics data for the gesture-intent-action tables may be received by the device. In some aspects, the success metrics data may comprise a set of success metrics scores, each corresponding to a set of gesture, intent, and action. A success metrics score may be a probability that a corresponding set of gesture, intent, and action will satisfy a user's intent.

At update operation 228, combinations of gesture-intent-action entries may be updated based on the success metrics. For example, the gesture-intent-action table may be revised according to success metrics data. Alternatively, the gesture-intent-action table may contain an additional column to store success metrics scores. This way, the table may contain multiple entries with different actions and success metrics scores for the same combination of gesture and intent. The success metrics scores may then be used to correctly identify an intent and action based upon the receipt of subsequent gestures.

In aspects, using the intent derived from a gesture may enable a search application to significantly improve accuracy of search results as well as efficiency of content layout management and cache management over conventional mechanisms for the presentation of search results and cache management. A gesture by itself may depict a command for next action without taking into consideration past patterns or subsequent need for additional or modified content. Utilizing a derived intent with success metrics may also provide for the derivation of an intent based upon the gesture using the history of user interactions to determine a next action that may more accurately identify an action to retrieve or present search result content. In some aspects the gesture mapping and client library may be updated based on success metrics scores. Subsequent processing of gesture-intent translations may use the latest gesture mapping to accurately capture user's intent during operations. As a result, various actions such as scrolling, providing details of search results as well as performance of fetching and providing contents based on intent as translated from gestures may change over time as the user continue to search for information using the device. In some other aspects the success metrics and updated mapping and client library may be shared across multiple users such that tendencies of gesture-intent mapping among users who use different devices may be captured to maintain accuracy in gesture-intent translations.

As should be appreciated, operations 220-228 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

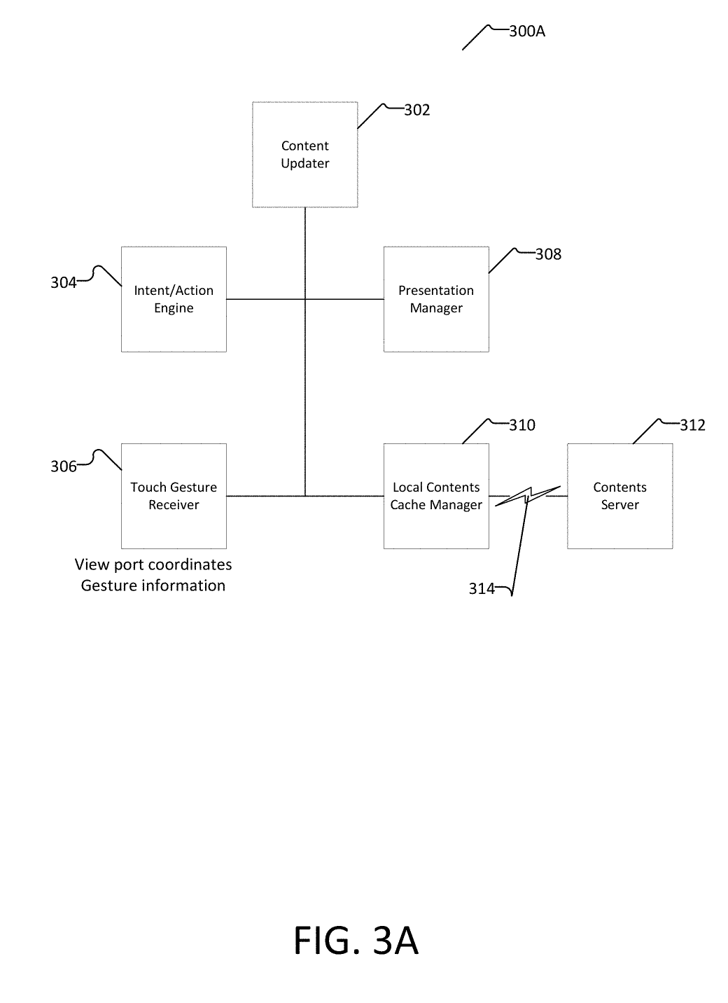

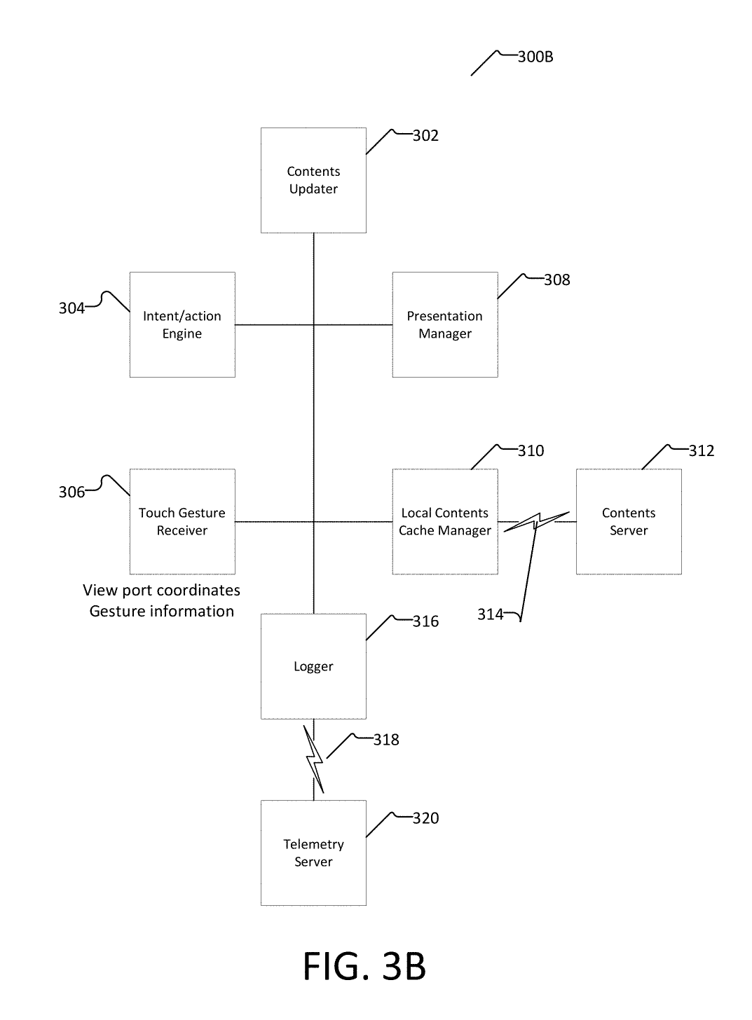

FIG. 3A illustrates a block diagram of components of the example system for a search application. According to the present disclosure, the example system 300A may receive touch gestures on the device that displays search query and result pages, and update search result content based on intent derived from the received gesture.

Content Updater 302 may update one or more content items in the search result. The one or more updated content may be associated one or more content containers in a search result. The content containers may identify different types of content based upon a type (e.g., images, video, documents, etc.) or a category (e.g., news, web pages, maps, answers, etc.). The updated content item(s) may be displayed with the search results using the Presentation Manager 308. Content Updater 302 may determine which content to update by selecting a content container based on location of a received gesture. Content Updater 302 may determine how to update the content based on an action as determined by Intent/Action engine 304.

Touch Gesture Receiver 306 may receive gesture information from the device as the device detects user interactive gestures. In some aspects, touch gestures may comprise tapping on one or more locations on the screen, selecting and swiping at various level of speeds at various length and directions, pinching zoom-in/zoom-out and other input gestures as predefined in the device. Touch gestures may also include, but not limit to, panning to the right and panning to the left.

Intent/Action engine 304 may determine intent and action based on received touch gesture. In some aspects, the Intent/Action engine 304 may look-up the gesture-intent-action table as shown in FIG.4 to select an intent and an action based on touch gesture data that is received by Touch Gesture Receiver 306. One of skill in the art will appreciate that other mechanisms for determining an intent based upon a gesture may be employed without departing from the scope of the invention. Further, in aspects, the intent may be determined based upon other types of input in addition to or instead of a gesture.

Presentation Manager 308 may manage layout and rendering of search content on the device. For instance, Presentation Manager 308 may manage a set of content containers in different areas in the touch screen display. Different content items of the search result may be placed in content containers. Content Updater 302 may rely upon Presentation Manager 308 to manage consistency and integrity of the layout on the page across different content containers.

Local Content Cache Manager 310 may manage content data that is locally cached at the device. Data in the local content cache may be managed and updated by Content Updater 302 based on actions as determined according to gesture and intent. For instance, as the search result page is slowly scrolled downward based on a gesture as detected from slow upward swipe on the page, local content cache may temporarily store content data that are associated with search result items on the search result list. Content on additional search result items may be pre-fetched from the Content Server 312 via the network 314. This way, user interactions on search result pages may be presented without interruptions.

Content Server 312 may store and manage content to be received by the devices as a result of searches. In some aspects, Content Server 312 and Local Content Cache Manager 310 may be connected via a network 314.

As shown in FIG. 3A, touch gesture information, including a location of the gesture, on the search result page may be received by Touch Gesture Receiver 306. Intent and action of the touch gesture from user interaction based on the touch gesture may be determined by the Intent/Action Engine 304. According to the determined action, the content may be retrieved by Content Updater 302, as Content Updater 302 instructs Local Content Cache Manager 310 provides the content data. Local Content Cache Manager 310 may pre-fetch content data from Content Server 312 via network 314. The content for updating may then be provided by the Presentation Manager 308.

FIG. 3B illustrates a block diagram of example components of the disclosed search result content placement system for training a process to determine an intent and action based upon a gesture such that a gesture-intent-action mapping remains accurate. According to the present disclosure, the example system 300B may record processing of receiving gestures on the search result page, determining intent and action based on the gestures, updating and presenting search results, and subsequent gestures received on the device upon the presented search results.

Logger 316 may receive touch gesture data from Touch Gesture Receiver 306 for logging. Look-up operations that may follow based on the received touch gesture may be received from the Intent/Action Engine 304 for logging. Events that relate to updating content and presenting search results may be collected from Content Updater 302 and Presentation Manager 308 for logging. One or more subsequent touch gestures on the updated search result page and determined intent based on the subsequent touch gestures may be received for logging. Logger 316 may send the log data to Telemetry Server 320 via network 318.

Telemetry Server 320 may receive and analyze the log data to generate success metrics data. In some aspects, the logger may associate a sequence of a first received touch gesture and corresponding intent and action, and a subsequent gesture along with corresponding determined intent. When updated success metrics scores for mapping among gesture, intent, and actions becomes available, the updated success metrics scores may be sent to Intent/Action Engine 304 on the device by the Telemetry Server 320. The success metrics data may be used by Intent/Action Engine 304 to improve accuracy in determining intent and action based on gesture.

As should be appreciated, the various methods, devices, components, etc., described with respect to FIGS. 3A and 3B are not intended to limit the systems and methods to the particular components described. Accordingly, additional topology configurations may be used to practice the methods and systems herein and/or some components described may be excluded without departing from the methods and systems disclosed herein.

FIG. 4 describes an example mapping table. The table may contain gesture, intent, and action. As illustrated, the table may comprise three columns: gesture, intent, and action. The gesture column may contain various different types of gestures that may be detected by the device. A gesture may comprise various factors of gesture: motion, and speed of the motion, direction of the motion, etc. The motion may comprise scrolling, swiping and pinching, among other motions. Scrolling and swiping gesture may comprise touching the touch screen display at some location on the touch screen display, and move in some direction at some speed. A pinch gesture may comprise at least two fingers or objects touching the touch screen display at the same time, and move along the surface in at least two directions for some distance and at some speed while touching. For instance, a gesture may be to scroll slowly in upward direction.

In some aspects, an intent may indicate what is expected through user interaction by updating search results. For instance, there may be an intent to read more items. The intent to read more items may indicate an expectation in the user interaction on the device to update the search result list in a way to display additional search result items to provide additional information about the item. Typically, the intent to read more items may describe a situation where the search result content is satisfying expectations of the users who submitted the query. On the other hand, an intent to jump within a page may indicate that the search result content does not satisfy expectations of a user. There may be an intent to skip to another location within the page. In some aspects, there may be other types of intent such as read more details and read less details.

In some aspects, an action may indicate a type of updating content on the device. For instance, an action to display more items below may specify updating content to display additional search result items attached to the items currently being displayed as a search result list on the device. There may be other actions such as but not limited to display more items above, to load footer of the page, to load header of the page, to load detailed content as an overlay with additional details, as well as to load abstract content. In aspects, loading footer of the page may result in displaying the bottom of the search result page. Loading a header section of the page for updating the content may result in displaying the top of the search result page. Loading detailed content as an overlay with additional details may result in displaying additional details of select search result item above the search result list. For instance, a detailed information such as location, business hours, contacts and customer reviews about a particular flower shop may be displayed as an overlay on top of a list of search result items. Loading abstract content may result in displaying an overview or an abstract of select search result items.

The gesture-intent-action mapping table in FIG. 4 may provide a mapping relationship among gesture, intent, and action. Based on a touch gesture as received on the device, the mapping table may be used to determine intent and action to update content that satisfy expectations as conveyed through the received gesture. For instance, a gesture “Scroll: Slow: Update” may be mapped to an intent “Read More Items”, and to an action “Display more items below.” When a gesture of slow, downward scroll is received by the device, there may be a strong correlation between the gesture and an intent to read the search items list carefully. Accordingly, the search result list may updated based on the determined action “Display more items below.” A gesture of slow, downward scroll may be equivalent to a finger motion to slowly swipe upward on the screen.

In some aspects, a swipe gesture may be mapped to panning of content. Accordingly a corresponding action may be to move content to a specific direction as specified by the gesture. In addition the action may comprise adding more content such as a part of images that has been off-screen to be rendered on the screen display as the some part of original content moves off the screen display.

In some aspects, a received gesture may indicate that the presented search results are not satisfactory, and some other search results may be desired by the user. When a received gesture indicates a fast, downward scrolling on the search result page, the mapping table may enable to determine an intent to be a jump within the page, and accordingly the action to be to load footer of the page. Similarly, a gesture of a fast, upward scroll may imply a lack of interests in the search result list, and the intent may be to quickly skip to the top of the search page to enter a new query.

While not shown in FIG. 4, the gesture-intent-action mapping table may comprise an additional column to indicate success metrics scores for respective mapping relationships. In some aspects, a success metrics score assigned to a gesture-intent-action mapping may indicate a probability where the gesture-intent-action mapping satisfies expectations of the operator of the device. In particular, the mapping table with high success metrics score may indicate that updated search results and content based on the action as relates to the intent based on the received gesture are more likely to meet the expectation of the operator who entered the gesture than mapping with lower success metrics scores.

As should be appreciated, the various methods, devices, components, etc., described with respect to FIG. 4 is not intended to limit the systems and methods to the particular components described. Accordingly, additional table configurations may be used to practice the methods and systems herein and/or some components described may be excluded

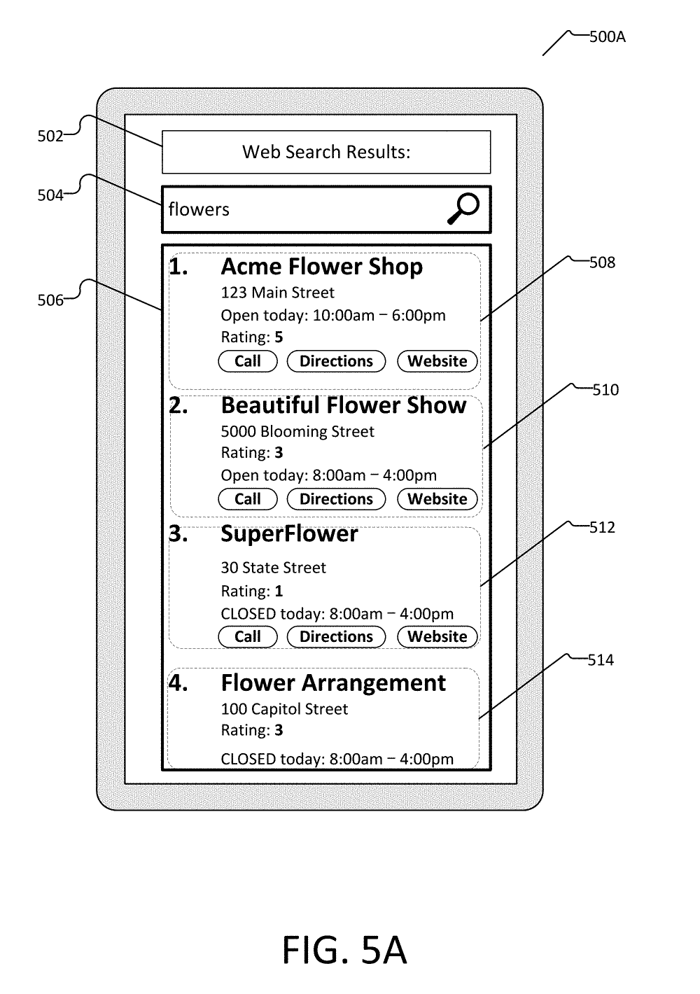

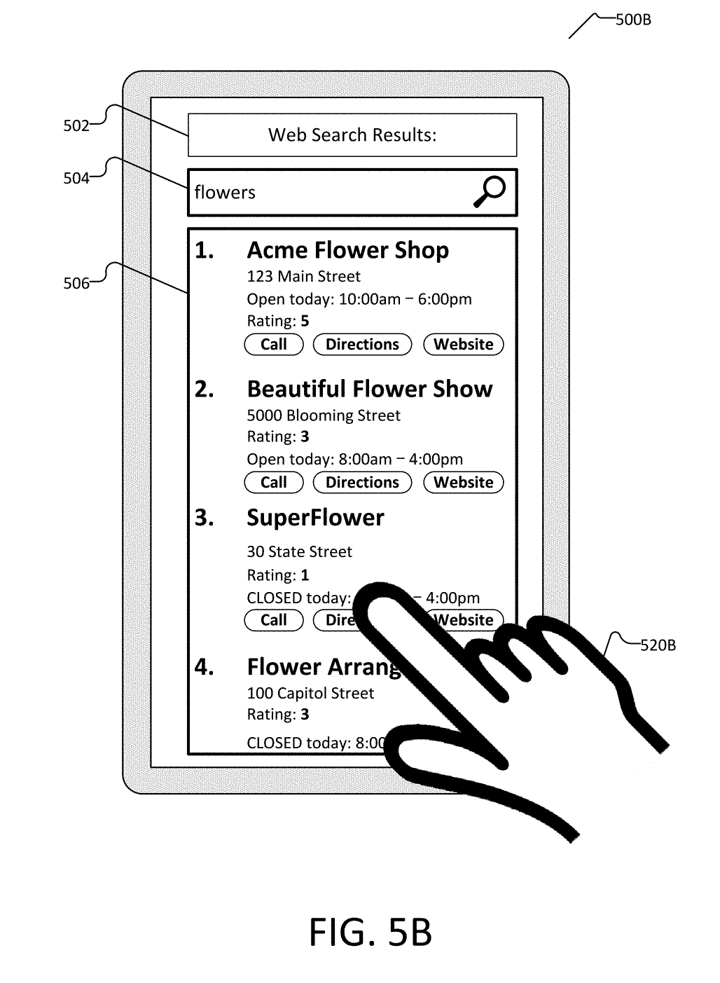

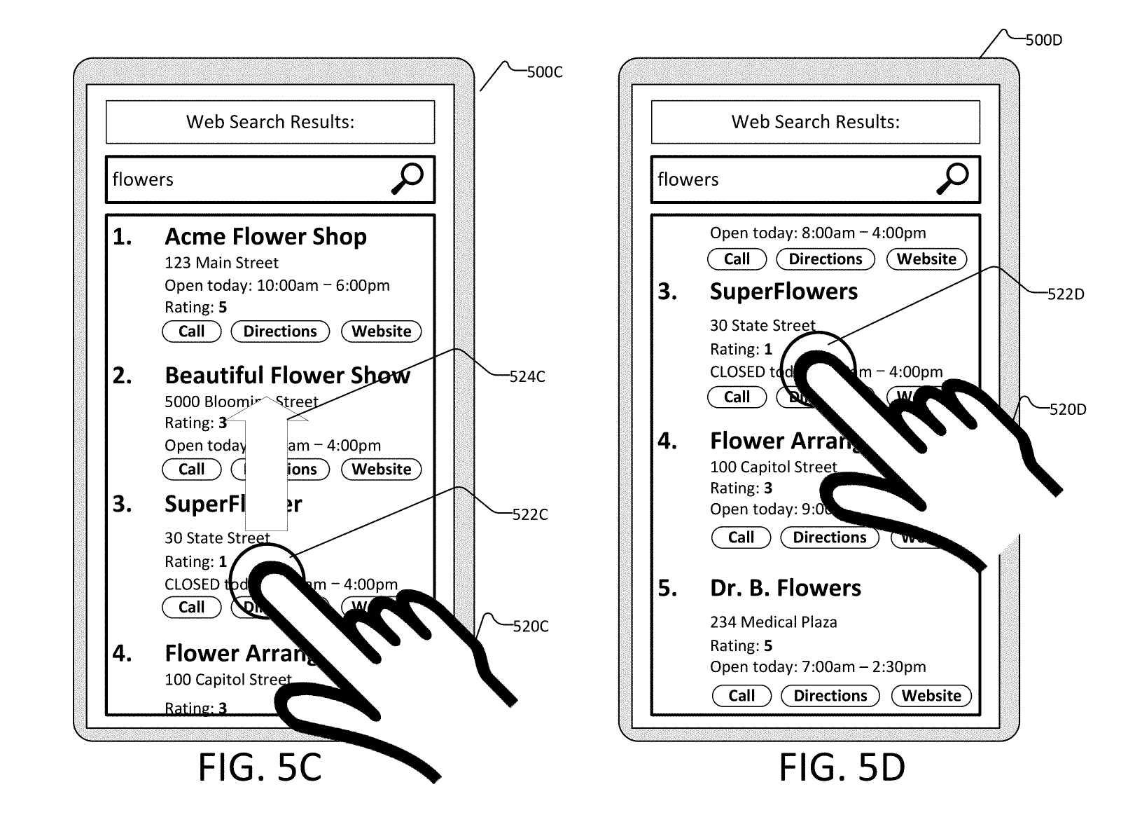

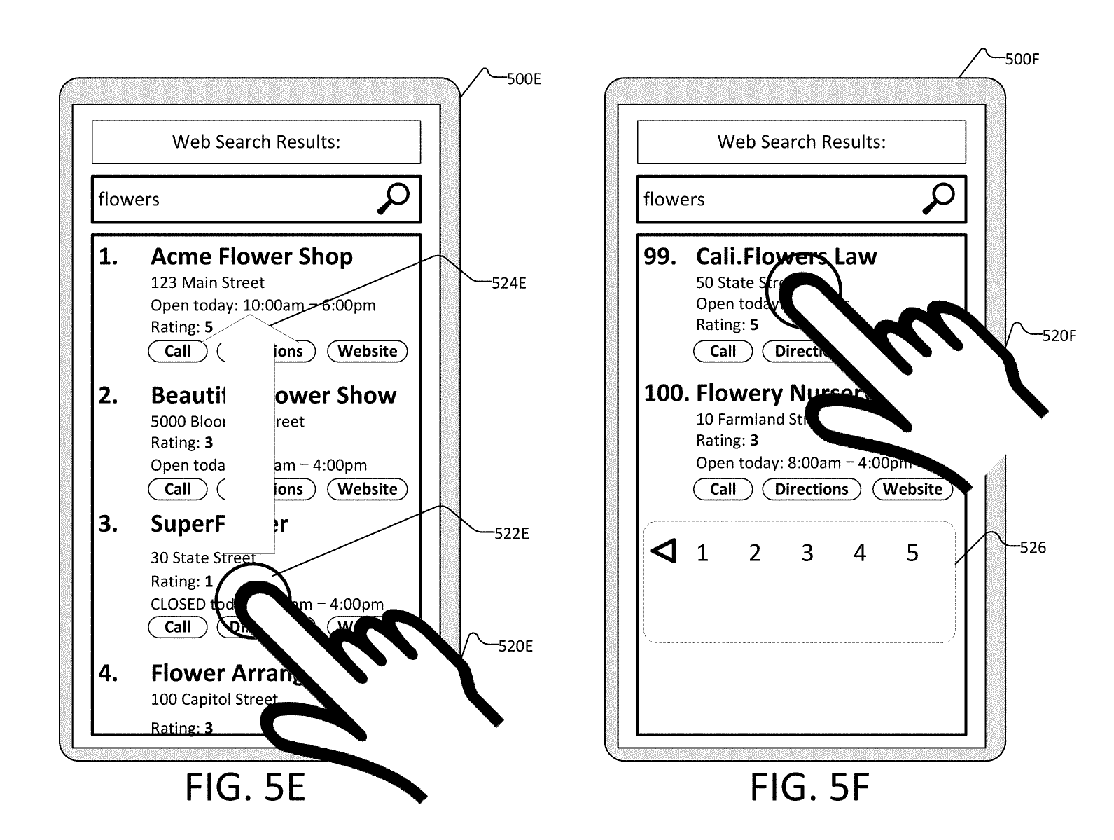

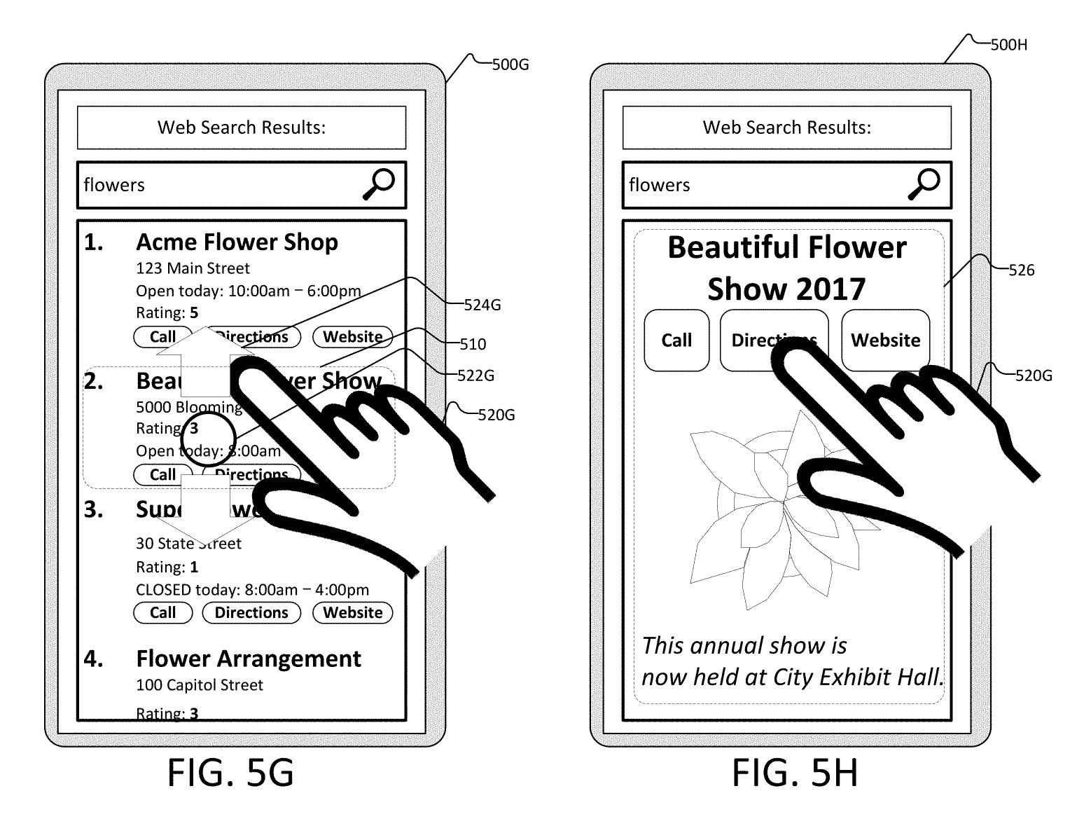

FIG. 5A depicts a graphical user interface (GUI) 500A displaying a search result page on a touch screen display of a smartphone, according to an example system. Interface 500A may include a title pane 502, indicating “Web search Results:” a search query input pane 504 where a search query may be entered, and search result list pane 506 where a list of search result is shown. Each item within the search result list may be assigned to a content container. For instance, content related to the first search result item “Acme Flower Shop” may be rendered in encapsulated manner in a first container 508. The first search result item may indicate a flower store as one of search result items based on the search using a query “flowers.” The first search result item may comprise an item number “1” and item name “Acme Flower Shop,” contact information such as an address of the store (such as “123 Main Street”), business hours (such as “Open today: 10:00 am-6:00 pm”), business review rating (such as “5”). In addition, the search result item may comprise one or more interactive buttons. For instance, selecting the “Call” button may cause the device to place a phone call to the store; selecting a “Directions” button may cause the device to provide a map and directions to the store from the current location. The “Website” button may cause the device to display a website or a virtual storefront of the store. As shown in FIG. 5C, a search result item may display information that is relevant to the item. Similarly, the second search result item “Beautiful Flower Show” may be in a second container 510. Third search result item “SuperFlower” is in a third container 512. The fourth search result item “Flower Arrangement” may on a fourth container 514. The content and the container move together as the page is scrolled. More search result items may appear on more containers when the page is scrolled.

FIG. 5B illustrates a graphical user interface (GUI) 500B displaying a search result page on a touch screen display of a smartphone, according to an example system. Interface 500B may receive gestures made on the touch screen display. For instance, as shown in FIG. 5B, a touch may be received to scroll the search results. If any one of the search result items needs to be the item may be selected by touching the screen display using some objects such as a finger of a hand 520B.

FIG. 5C and FIG. 5D illustrate a sequence of display content while receiving a touch gesture on web search results according to an example system. Interface 500C displays a web search result list. A finger of a hand 520C may be touching the touch screen as indicted by the circle 522C. The finger may slowly move in the upward direction, stops at some short distance, and detaches from the touch screen display. FIG. 5D illustrates a state where the motion of the finger 520D stopped and as the finger 520D detaches from the touch panel display, and the web search result items are updated to indicate the scrolled list. In some aspects the series of motion by the finger (520C and 520D) on the device may trigger the Touch Gesture Receiver 306 to receive a touch gesture event based on the movement. As illustrated in the step 104 of FIG. 1, a touch gesture information may be received at this time. The received gesture information may be translated into an intent, content for updating may be determined based on the intent. Content may be fetched from content server. Finally, the web search result content may be dynamically updated on the touch screen display as shown on FIG. 5D. As illustrated in the step 202 of FIG. 2A, the slow, scroll down gesture may be received. Along with the gesture, a location where the gesture was made on the touch screen display may be determined (as illustrated in step 204 of FIG. 2A). The gesture may then be translated into an intent “Read More Items” and an action “Display more items below” according to the gesture-intent-action mapping table as illustrated in FIG. 4. In this instance, it may be determined that the displayed results are relevant to a user's intent, so additional similar results may be retrieved and displayed. For instance, an additional search result item 5 “Dr. B. Flowers” may be displayed as shown in FIG. 5D. Additional web search result items may be retrieved to render the web search result list as the list is scrolled downward. The indicators such as the circular indicator 522C and the arrow 524C are used for illustrative purposes and may not necessarily be displayed on the touch screen display.

FIG. 5E and FIG. 5F illustrate a sequence of touch gesture and updating web search result content according to an example system. In Interface 500E, a web search result page with four search result items based on a search query “flowers” may be shown. Objects such as a finger of a hand 520E may touch the touch screen display of the device at a location as shown by the circle 522E, and move upward at a fast speed at a distance as indicated by the arrow 524E. The terminal location of the finger of the hand 520F is shown in FIG. 5F. According to the gesture received as shown in FIG. 5E, the Class Library such as the library shown in step 104 of FIG. 1 may identify as a fast, downward scroll. According to the gesture-intent-action mapping table of FIG. 4, such a gesture may be translated as an intent to jump within the page. Such an intent may be mapped to the gesture because the user interaction involving a fast scroll may be an indicative of a lack of interests in the current web search results and thus just jump to the end of the page based on the direction of the scroll. Accordingly, “Load footer of the page” may be determined as an action from the gesture-intent-action mapping table in FIG. 4. As shown FIG. 5F, the web search result page may comprise the last two items from web search result: item 99 “Cali. Flowers Law” (some law firm in town) and item 100. The footer pane 526 may contain a set of link to previous search result pages. The finger of the hand 520F may indicate the ending point of the gesture made on the touch screen display.

FIG. 5G and FIG. 5H illustrate receiving a pinch zoom-in gesture on the web search result page and an update on the touch screen display according to an example system. Interface 500G may show a web search results page. The finger of the hand 520G may use two fingers to “pinch zoom-in” at a location as shown in a circle 522G and respective fingers moving in opposite directions as shown in the two arrows 524G. The pinch zoom-out gesture may be received by the Touch Gesture Receiver 306 as shown in FIG. 3A. Based on the location 522G of the gesture, a corresponding content container 510 may be determined. Then, the received gesture of “Pinch to Zoom: In” may be translated into an intent “Read More Details” as well as a corresponding action “Load detailed content as an overlay with additional details,” according to the gesture-intent-action table as shown in FIG. 4. In some aspects, receiving the “pinch zoom-in” gesture may indicate that the search result items on the list as shown in FIG. 5G, particularly the selected search result item satisfies the interests of the device user as more details of the item is requested. According to the action as determined by the Intent/action engine 304 in FIG. 3A, Content Updater may request the content from Local Content Cache Manager 310 as shown in FIG. 3A. Then, the content of detailed information about the selected item “the Beautiful Flower Show” may be retrieved from a content server such as the content server 312 in FIG. 3A into the local cache by Local Content Cache Manager 310 via the network 314. The retrieved content may be used by the Content Updater 302 by requesting Presentation Manager 308 to display the detailed information about the flower show event on the touch screen display. The updated screen with the detailed information may be as shown in FIG. 5H.

As illustrated in the figures, a sequence of receiving a gesture, identifying intent and action from the gesture, preparing for updating the content according to the action and dynamically updating the content on the touch screen display may occur as the device continues to provide user interactions on the touch screen display. Caching content locally while prefetching content from remote servers via network may be processed concurrently on the device.

As should be appreciated, the various methods, devices, components, etc., described with respect to FIGS. 5A through 5H is not intended to limit the systems and methods to the particular components described. Accordingly, additional topology configurations may be used to practice the methods and systems herein and/or some components described may be excluded without departing from the methods and systems disclosed herein.

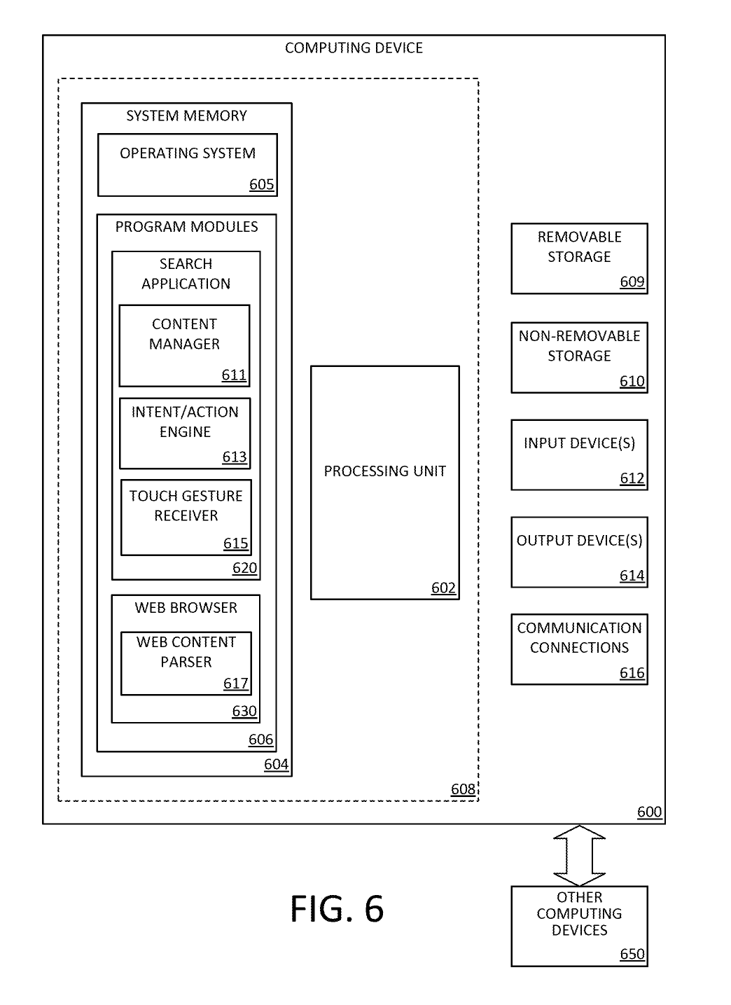

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may have computer executable instructions for implementing a search application 620 on a computing device, including computer executable instructions for search application 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for performing the various aspects disclosed herein. For example, the one or more program modules 606 may include a search application 620 for managing display of one or more graphical user interface objects and user interactions.

As illustrated by FIG. 6, search application 620 may include one or more components, including a content manager 611 for generating and updating content and search result items on output device(s) 614 such as a display, an intent-action engine 613 for determining intent and action based on various constraints and conditions including mapping among gestures, intents, and actions, and a touch gesture receiver 615 for receiving touch gestures made on input device(s) 612 including a touch screen display through graphical user interface. As illustrated by FIG. 6, a search application 620 may have access to Web Browser 630, which may include or be associated with a web content parser to render and control web search results on the web browser. In further examples, the one or more components described with reference to FIG. 6 may be combined on a single computing device 600 or multiple computing devices 600.

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., search application 620) may perform processes including, but not limited to, the aspects, as described herein. Other program modules that may be used in accordance with aspects of the present disclosure, and in particular for managing display of graphical user interface objects, may include content manager 611, intent-action engine 613, touch gesture receiver 615, web browser 630, and/or web content parser 617, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As should be appreciated, FIG. 6 is described for purposes of illustrating the present methods and systems and are not intended to limit the disclosure to a particular sequence of steps or a particular combination of hardware or software components.

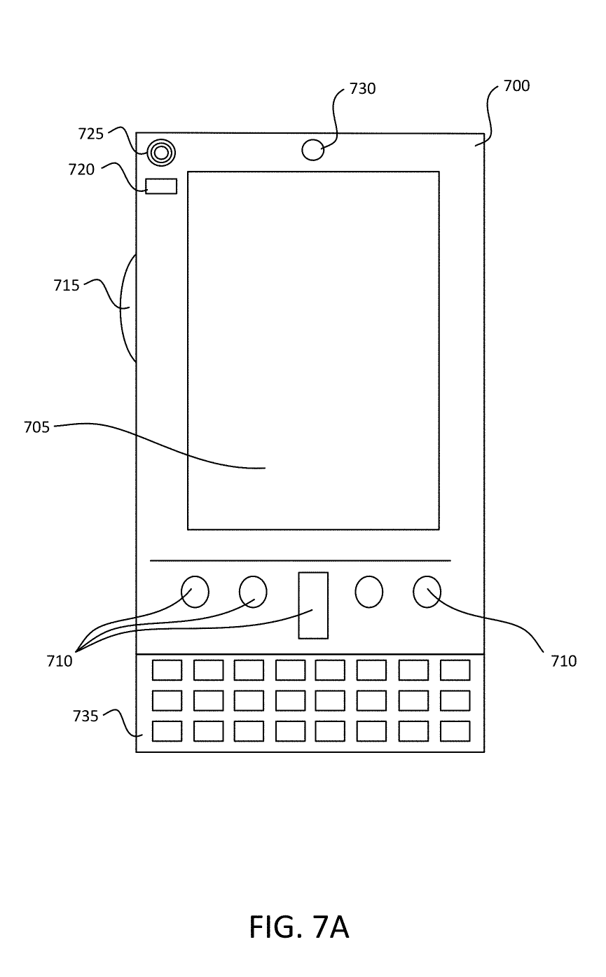

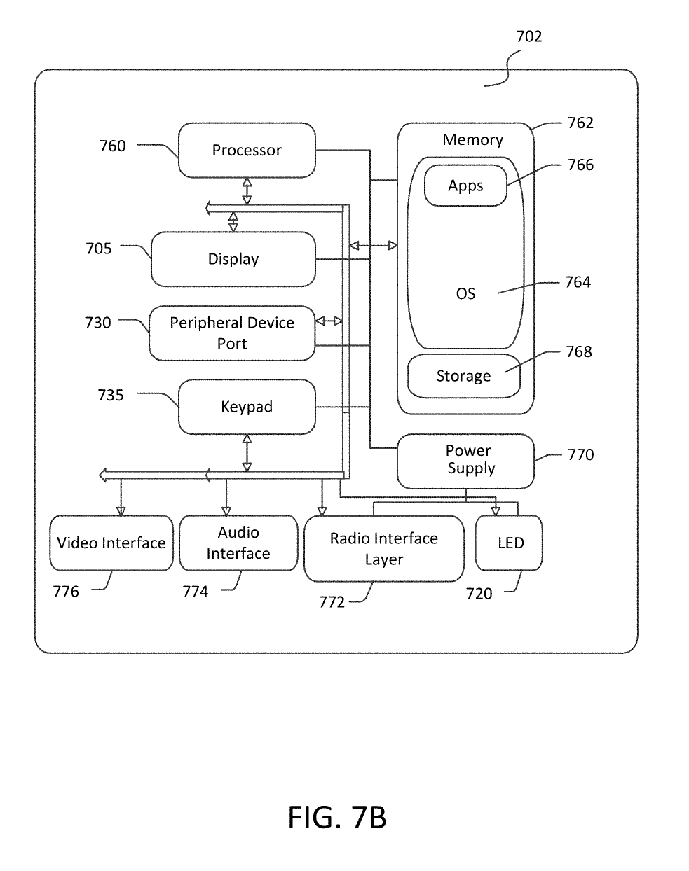

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as email or other messages used by an email application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing a consensus determination application as described herein (e.g., message parser, suggestion interpreter, opinion interpreter, and/or consensus presenter, etc.).

The system 702 has a power supply 770, which may be implemented as one or more batteries. The power supply 770 may further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via an audio transducer 725 (e.g., audio transducer 725 illustrated in FIG. 7A). In the illustrated embodiment, the visual indicator 720 is a light emitting diode (LED) and the audio transducer 725 may be a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of peripheral device 730 (e.g., on-board camera) to record still images, video stream, and the like. Audio interface 774, video interface 776, and keypad 735 may be operated to generate one or more messages as described herein.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

As should be appreciated, FIGS. 7A and 7B are described for purposes of illustrating the present methods and systems and are not intended to limit the disclosure to a particular sequence of steps or a particular combination of hardware or software components.

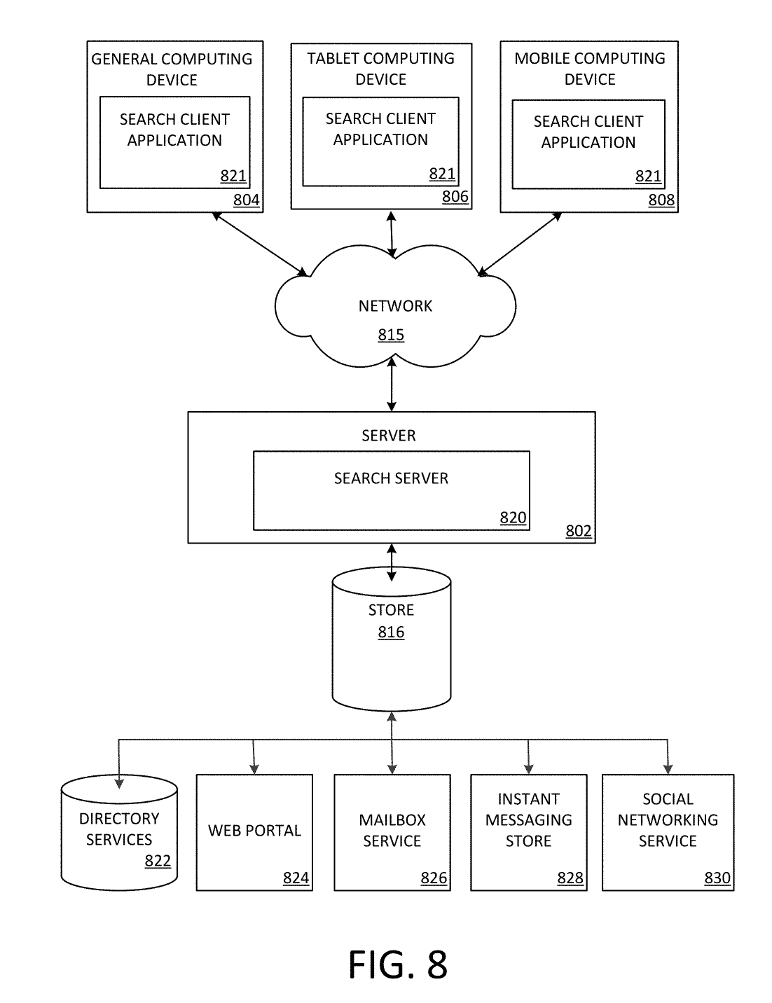

FIG. 8 illustrates one aspect of the architecture of a system for processing data received at a computing system from a remote source, such as a general computing device 804 (e.g., personal computer), tablet computing device 806, or mobile computing device 808, as described above. Content displayed at server device 802 may be stored in different communication channels or other storage types. For example, various messages may be received and/or stored using a directory service 822, a web portal 824, a mailbox service 826, an instant messaging store 828, or a social networking service 830. The User Interface View Manager 821 may be employed by a client that communicates with server device 802, and/or the logics and resource manager 820 may be employed by server device 802. The server device 802 may provide data to and from a client computing device such as a general computing device 804, a tablet computing device 806 and/or a mobile computing device 808 (e.g., a smart phone) through a network 815. By way of example, the computer system described above with respect to FIGS. 1-5 may be embodied in a general computing device 804 (e.g., personal computer), a tablet computing device 806 and/or a mobile computing device 808 (e.g., a smart phone). Any of these embodiments of the computing devices may obtain content from the store 816, in addition to receiving graphical data useable to either be pre-processed at a graphic-originating system or post-processed at a receiving computing system.

As should be appreciated, FIG. 8 is described for purposes of illustrating the present methods and systems and is not intended to limit the disclosure to a particular sequence of steps or a particular combination of hardware or software components.

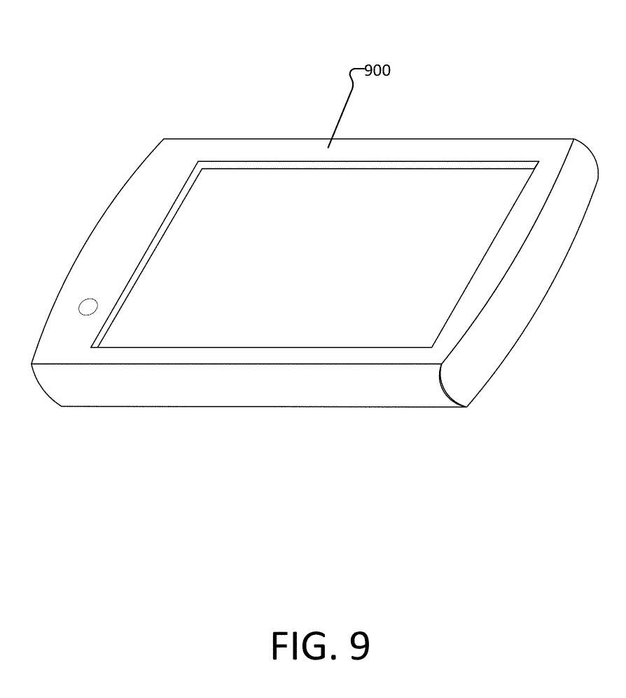

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 9 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method for updating search results based on gesture input on a mobile device, the method comprising:
receiving at least one gesture on search result page on a touch screen display;
determining at least one location based on the received at least one gesture;
determining an intent based on the received gesture;
determining an action based on the determined intent.
retrieving at least one content item based on the at least one action and the location; and
updating the search results with the at least one content item.

2. The computer-implemented method of claim 1, wherein each of the at least one gesture comprises at least one of:
a direction,
a speed,
a length,
a pressure level,
coordinates of an initial touch point, and
coordinates of an end touch point.

3. The computer-implemented method of claim 1, wherein the at least one gesture comprises at least one of:
scrolling slowly upward;
scrolling slowly downward;
scrolling fast upward;
scrolling fast downward;
pinching zoom-in;
pinching zoom-out;
swiping left; and
swiping right.

4. The computer-implemented method of claim 1, further comprises:
determining a content container based on the at least one location;
retrieve one or more additional content items based on the action; and
update the content container with the one or more additional content items.

5. The computer-implemented method of claim 1, further comprises:
collecting search activity data;
based upon the collected search activity data, obtaining success metrics data; and
updating a first association between gesture and intent based on the success metrics data.

6. The computer-implemented method of claim 5, wherein the search activity data comprises:
a search query;
a first gesture from the at least one gesture;
a first mapping between the first gesture and a first intent;
a second gesture from the at least one gesture; and
a second mapping between the second gesture and a second intent; and
wherein the success metrics data is based on difference between the first intent and the second intent.

7. The computer-implemented method of claim 1, wherein the at least one intent comprises at least on of:
reading more items;
jumping within the search result page;
reading more details;
reading less details;
viewing similar search results; and
viewing different search results.

8. The computer-implemented method of claim 1, wherein the at least one action comprises at least one of:
displaying more items above;
displaying more items below;
loading header of the page;
loading footer of the page;
loading detailed content as an overlay with additional details;
loading abstract content;
moving the content to the left while adding the content from the right; and
moving the content to the left while adding the content from the left.

9. The computer-implemented method of claim 1, further comprising:
logging a gesture-intent-action entry look-up and subsequent query operations;
sending the logged gesture-intent-action entry look-up and the subsequent query operations to a telemetry service;
receiving the success metrics data from the telemetry service; and
updating gesture-intent-action entries based on the success metrics.

10. The computer-implemented method of claim 9, further comprising:
generating, by the telemetry server, success metrics data for the gesture-intent-action entries, wherein the telemetry server is connected to the device via a communication network.

11. The computer-implemented method of claim 1, further comprising:
determining the intent based on a gesture-intent mapping table;
determining the action based on an intent-action mapping table.

12. The computer-implemented method of claim 11, wherein the gesture-intent mapping table comprises a slow upward scroll gesture mapped to a first intent to read similar content items on the search result page, and wherein the intent-action mapping table comprises the first intent mapped to a first action of displaying the similar content items.

13. The computer-implemented method of claim 11, wherein the gesture-intent mapping table comprises fast upward scroll gesture mapped to a first intent of jumping to the top of the search result page, and wherein the intent-action mapping table comprises first intent mapped to a first action of loading a header of the search result page.

14. A computer system comprising:
at least one processing unit; and
at least one memory storing computer-executable instruction that ,when executed by the at least one processing unit, cause the computer system to perform a method of automatically updating search results on a search application based on gesture input, the method comprising:
identifying a gesture on a search result page on a screen;
translating the gesture into an intent;
determining an action based on the intent;
determining update content based upon the action;
retrieving the update content; and
dynamically updating the search result page with the update content.

15. The computer system of claim 14, wherein the method further comprises determining a content container based on at least one location of the gesture, wherein determining the update content further comprises determining the update content based at least upon the content container.

16. The computer system of claim 14, wherein the method further comprises:
translating the gesture based on a gesture-intent mapping table; and
determining the action based on a intent-action mapping table.

17. The computer system of claim 14, wherein the gesture-intent mapping table comprises a slow upward scroll gesture mapped to a first intent to read similar content items on the search result page, and wherein the intent-action mapping table comprises the first intent mapped to a first action of displaying the similar content items.

18. The computer system of claim 14, wherein the gesture-intent mapping table comprises fast upward scroll gesture mapped to a first intent of jumping to the top of the search result page, and wherein the intent-action mapping table comprises first intent mapped to a first action of loading a header of the search result page.

19. A computer storage medium comprising computer-executable instructions that when executed by a processor to perform a method of automatically updating search results on a search application based on gesture input on a mobile device, the method comprising:
identifying a gesture on a search result page on a screen;
translating the gesture into an intent;
determining an action based on the intent;
determining update content based upon the action;
retrieving the update content; and
dynamically updating the search result page with the update content.

20. The computer storage medium of claim 19, wherein the method further comprises determining a content container based on at least one location of the gesture, wherein determining the update content further comprises determining the update content based at least upon the content container.
